(19) United States
(12) Patent Application Publication
(10) Pub. No.: US 2015/0345203 A1
(43) Pub. Date: Dec. 3, 2015

(54) HINGE FOR DOORS OF ELECTRICAL HOUSEHOLD APPLIANCES

(71) Applicant: NUOVA STAR S.p.A., Zola Predosa (Bologna) (IT)

(72) Inventor: Marco VANINI, Bologna (IT)

(21) Appl. No.: 14/718,578

(22) Filed: May 21, 2015

(30) Foreign Application Priority Data
May 28, 2014 (IT) BO2014A000315

(51) Int. Cl. E05F 3/20; E05F 3/14; E05D 3/02

(52) U.S. Cl. CPC E05F 3/20; E05D 3/02; E05F 3/14

(57) ABSTRACT

A hinge for doors of appliances includes a movable arm connected to a door of the appliance, pivoted on a frame to rotate about an axis to make the door movable relative to the frame between closed and open positions. A control shaft extends longitudinally parallel to the axis and is connected to the frame. A sleeve attached to the movable arm extends parallel to the axis. An elastic element is contained inside the sleeve to generate an elastic force for closing the door. A mechanism drives the elastic element to determine the deformation and transmit to the movable arm the closing force. The mechanism includes two cylindrical cam operating units housed inside the sleeve, having first and second cylindrical cams operatively facing one another such that rotation of one about the axis determines translation of the other along the same axis and vice versa,

This application claims priority to Italian Patent Application BO2014A000315 filed May 28, 2014, the entirety of which is incorporated by reference herein.

### BACKGROUND OF THE INVENTION

This invention relates to a hinge for doors of electrical household appliances.

More specifically, this invention relates to a hinge for doors of refrigerators.

For connecting the doors of the refrigerators to the respective frame the prior art uses hinges with a vertical extension with cylindrical cams which, thanks to their inclined profile, allow a predetermined closing force to be transferred to the door.

The closing force can be generated either by the weight of the door or by the action of a spring.

The transformation of the weight force into twisting moment is caused by the inclination of the cylindrical cam profile. In effect, thanks to this inclination, the force which is transmitted between the inclined surfaces of the cams, in reality a cam and a follower, has a horizontal component which due to the distance between its point of application from the axis of rotation, determines a twisting moment for a part of the hinge integral with the door. It is precisely this twisting moment which causes the door to close relative to the frame.

A drawback connected to the use of hinges of the type described above, using the weight force to determine the closing of the door and for this reason also defined as “gravity” type, is due to the fact that during the opening of the door, in order to accumulate the necessary potential energy, the door itself must rise, thus introducing instability to the system. In other words, the fact that the door of the refrigerator is normally loaded with food inside it means that its weight is extremely variable and the closing force depends on variable elements.

In order to overcome these drawbacks springs have been used which are able to accumulate, during the opening of the door, an elastic energy sufficient to apply a sufficient twisting moment to guarantee the closing of the door.

In this type of hinge, helical springs are normally used which, compressed during the opening of the door, release the accumulated elastic energy, facilitating the closing thanks to the action of cylindrical cams.

This latter type of hinge, although it solves the above-mentioned problems which are typical of the so-called “gravity” hinges, is not itself free from drawbacks.

A drawback relative to the hinges of this type is, for example, linked to the difficulty of managing the elastic force, in particular in the provision of the closing thrust.

A further drawback in the prior art hinges is due to their extreme constructional complexity.

### SUMMARY OF THE INVENTION

The aim of this invention is, therefore, to overcome the drawbacks indicated above and provide an alternative to the prior art hinges described above.

Another aim of this invention is to provide a hinge for doors of electrical household appliances which is inexpensive to manufacture, efficient to operate and easy to maintain.

This invention accordingly provides a hinge for doors of electrical household appliances comprising the features described in any of the appended claims.

### BRIEF DESCRIPTION OF DRAWINGS

The technical features of the invention, with reference to the above aims, can be easily inferred from the appended claims, in particular claim 1, and preferably any of the claims that depend, either directly or indirectly, on claim 1.

The advantages of the invention are more apparent from the detailed description which follows, with reference to the accompanying drawings which illustrate a preferred, non-limiting example embodiment of the invention and in which:

FIG. 1 is an exploded schematic view of a preferred embodiment of a hinge according to this invention;

FIGS. 2, 3, 4 and 5 illustrate, in respective schematic perspective views from above with some parts cut away to better illustrate others, the hinge of FIG. 1 in four its different operating steps;

FIGS. 2a, 3a, 4a and 5a are respective schematic plan views from below of the hinge of FIGS. 2, 3, 4 and 5;

FIG. 6 is a schematic front elevation view, with some parts transparent, of the hinge of the preceding drawings.

### DESCRIPTION OF PREFERRED EMBODIMENTS

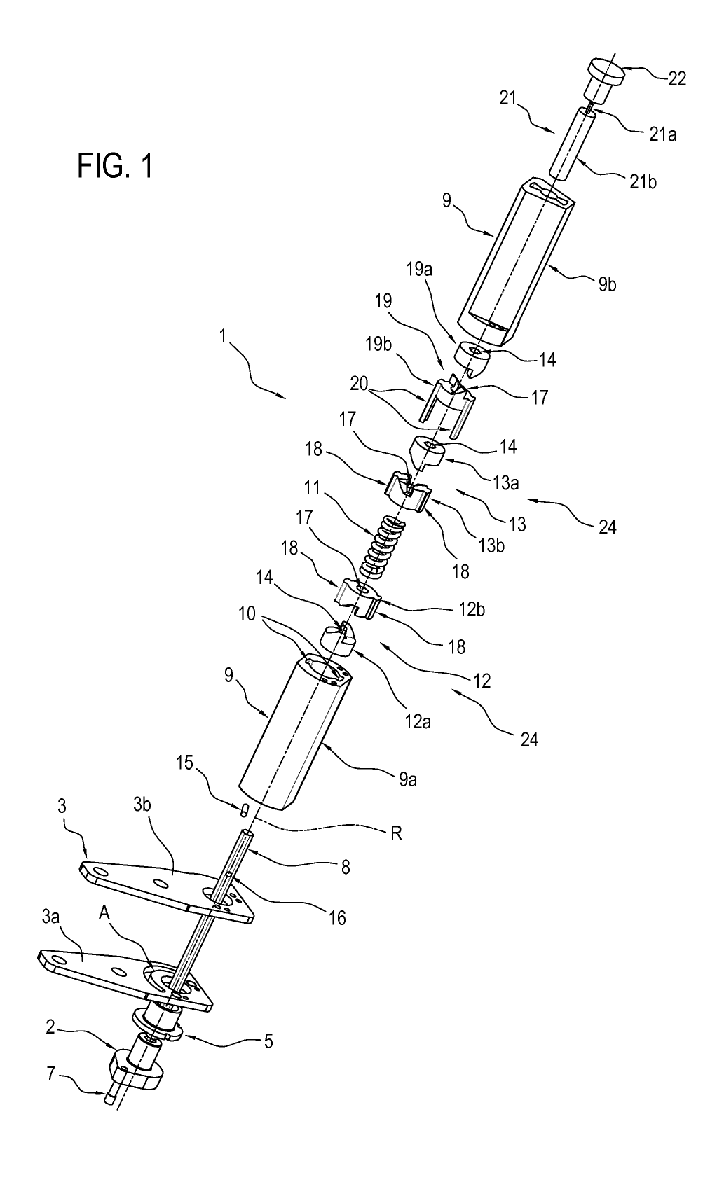

With reference to FIG. 1, the numeral 1 denotes in its entirety a hinge for doors of electrical household appliances made in accordance with this invention.

Preferably, but without limiting the invention, the term “electrical household appliance” used in this description refers to a refrigerator.

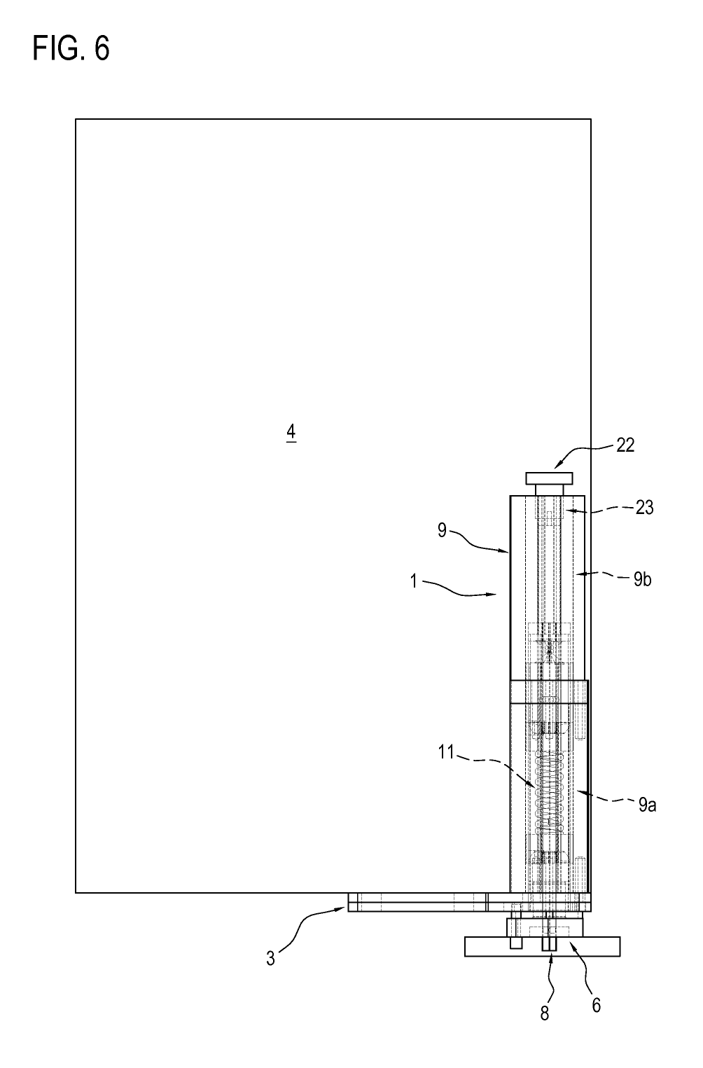

With reference to FIG. 1, the hinge 1 comprises a fixed body 2, connectable as one with to a frame, not illustrated, of the electrical household appliance, and a movable arm 3, connected to a door 4 of an electrical household appliance, shown in FIG. 6.

The hinge 1 is designed to make the door 4 movable relative to the above-mentioned frame, not illustrated, between a closed position and an open position.

The movable arm 3 is pivoted on the fixed body 2, by an interposed bush 5, to rotate relative to it about a respective axis R of rotation.

With reference to FIG. 6, the fixed body 2 is supported by a bracket 6 integral with the frame, not illustrated, of the electrical household appliance.

Again with reference to FIG. 1, the movable arm 3 advantageously comprises two flat plates 3a, 3b overlapping each other.

On one 3a of the plates a slot A with a curved semi-circular extension is made which, during the relative rotation of the arm 3 and the body 2, is slidably engaged with a pin 7 emerging from the fixed body 2.

The pin 7 defines an end of stroke element for the arm and the door 4 integral with it.

The hinge 1 comprises a control shaft 8, extending longitudinally parallel with the axis R and stably connected to the fixed body 2 at a relative first lower end 8a.

The control shaft 8 has a polygonal cross section, advantageously hexagonal.

The hinge 1 comprises a hollow sleeve 9 for housing the elements making up the hinge 1, the sleeve 9 comprising a lower portion 9a and an upper portion 9b.

The sleeve 9 is integral with the above-mentioned movable arm 3 and connected to it close to an end of its lower portion 9a.

The sleeve 9 extends longitudinally parallel to the axis R of rotation of the hinge 1.

On the inner cylindrical surface of the sleeve 9 there are two longitudinal sockets 10, positioned diametrically opposed to each other relative to the axis R of extension of the sleeve 9.

The hinge 1 comprises, fitted on the shaft 8, a helical spring 11, a first operating unit 12 and a second operation unit 13.

The two operating units 12, 13 are positioned on both sides of the helical spring 11, to act on the spring 11.

The helical spring 11 defines, for the hinge 1, a respective elastic element.

For this purpose, each operating unit 12, 13 comprises a first and a second cylindrical cam, respectively labelled 12a, 13a and 12b, 13b.

The first 12a, 13a and second 12b, 13b cylindrical cams of each operating unit 12, 13 have respective profiles having inclined portions shaped to be positioned, facing each other, in contact with each other.

These inclined portions of the profiles are designed, in known manner, to determine for each unit 12, 13, by the rotation of a cam, the translation of the other and vice versa.

Advantageously, the profile of each first 12a, 13a and second 12b, 13b cam also has a horizontal portion, that is, lying in a plane perpendicular to the axis R of rotation, which is able to guarantee, as described in more detail below, the maintaining of a stable angular position between the fixed body 2 and the movable arm 3.

The first cam 12a, 13a of each first and second operating unit 12, 13, has a central hole 14 shaped to match the cross section of the control shaft 8.

In that way, when fitted on the shaft 8, the above-mentioned first cams 12a, 13a are rotatably integral with it.

A pin 15 is inserted in a respective hole 16 made on the shaft 8 for defining a contrast element abutting the second operating unit 13 and, in particular for its second cylindrical cam 13b.

The second cam 12b, 13b of each first and second operating unit 12, 13 has a central hole 17 for the passage of the control shaft 8, in such a way that, when fitted on the shaft 8, the above-mentioned second cams 12b, 13b are rotatably independent from it.

The second cam 12b, 13b of each first and second operating unit 12, 13 also has, on its cylindrical outer surface, two lateral appendages 18 extending parallel to the axis R of rotation.

Each of the appendages 18 is designed to engage slidably inside a respective socket 10 of the sleeve 9 for allowing, in use, the longitudinal sliding of the second cam 12b, 13b relative to the sleeve 9, as well as their integral rotation relative the axis R.

In other words, the sockets 10 define, for the above-mentioned longitudinal appendages 18, respective longitudinal guides of the translation of the second cam 12b, 13b.

The hinge 1 also comprises, adjacent to the above-mentioned second operating unit 13, a third operating unit 19 with cylindrical cams.

The third operating unit 19 also comprises a first and a second cylindrical cam, respectively labelled 19a and 19b.

The first and second cylindrical cams 19a, 19b of the third operating unit 19, in a similar fashion to those of the above-mentioned first and second unit 12, 13, also have respective inclined profiles shaped to be positioned, facing each other, in contact with each other.

As clearly illustrated in FIG. 1, the first cam 19a of the third operating unit 19 has a respective central hole 14 shaped to match the cross section of the control shaft 8 in order to be, when fitted on the shaft 8, rotatably integral with it.

The second cam 19b of the third operating unit 19 has a central hole 17 for the passage of the control shaft 8, in such a way as to be, when fitted on the shaft 8, rotatably independent from it.

The second cam 19b of the third operating unit 19 also has, on its cylindrical outer surface, two lateral appendages 20 which project longitudinally beyond the overall dimensions of second cam 19b.

More in detail, as illustrated in the accompanying drawings, the lateral appendages 20 project until reaching the second operating unit 13, adjacent to the third unit 19 and located inside the sleeve 9.

More specifically, in the mounted hinge 1, these lateral appendages 20 project longitudinally until coming into contact with the second cylindrical cam 13b of the second operating unit 13, passing beyond the physically adjacent first cam 13a.

Similarly to the appendages 18 of the second cams 12b, 13b, the lateral appendages 20 also engage slidably inside the longitudinal sockets 10 of the sleeve 9.

The hinge 1 also comprises a shock absorbing cylinder 21 housed inside the sleeve 9.

Advantageously, the shock absorbing cylinder 21 is of the fluid or gas type.

The fluid or gas shock absorbing cylinder 21 comprises a fixed part 21a and a movable part 21b relative to the sleeve 9, with the shock absorbing action performed following a relative movement of the fixed 21a and movable 21b parts.

The shock absorbing cylinder 21 also has an element 22 for adjusting the preloading, which is advantageously engaged by screwing on a corresponding threaded portion 23 of the cylindrical inner surface of the second upper portion 9b of the sleeve 9.

The shock absorbing cylinder 21 defines for the hinge 1 respective shock absorbing means designed to exert on the movable arm 3 a shock absorbing action in its motion relative to the fixed body 2, close to reaching the above-mentioned closed position of the door 4.

The first, second and third operating units 12, 13, 19 define, for the hinge 1, respective means 24 for driving the elastic means 11 as well as the above-mentioned shock absorbing cylinder 21.

The shock absorbing action is in effect exerted by the shock absorbing means on the movable arm 3 also through the above-mentioned drive means 24.

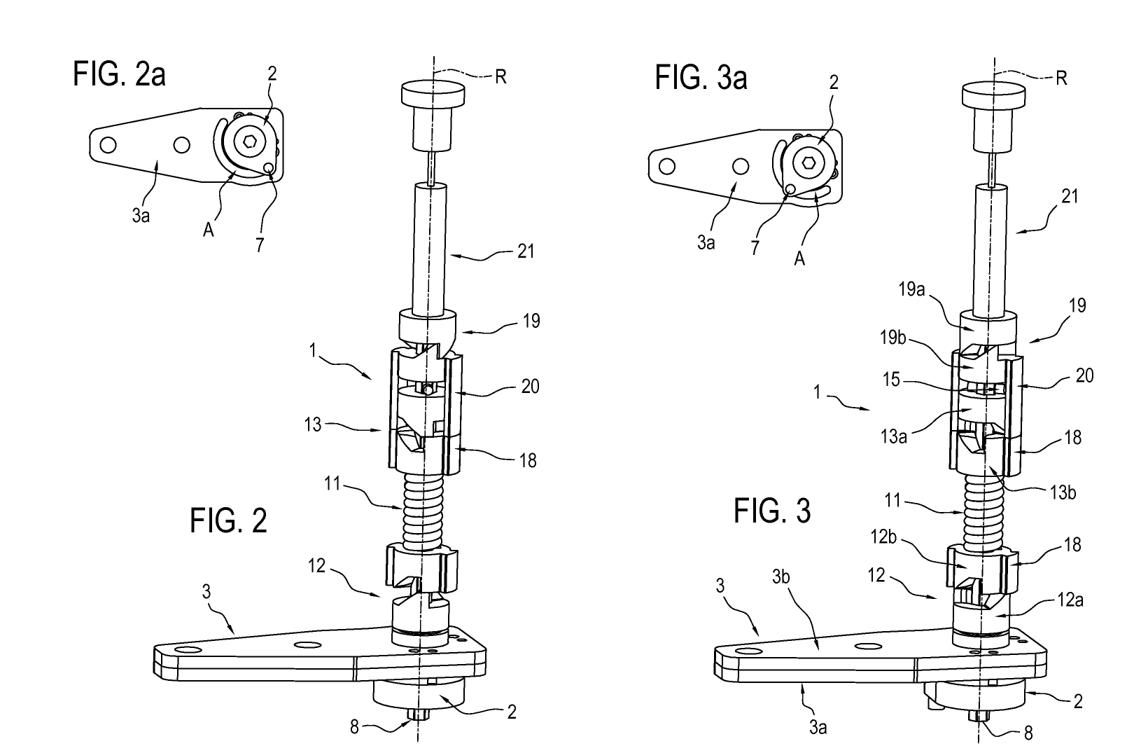

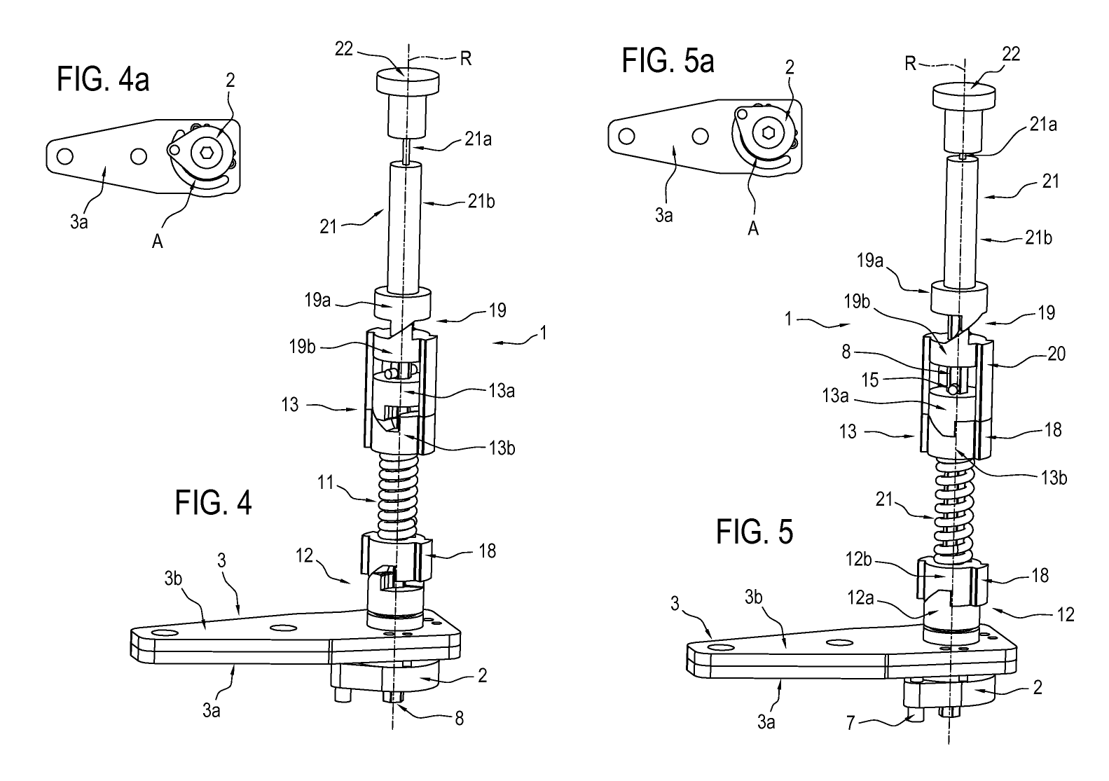

In use, as illustrated in FIG. 2 which shows a configuration of the hinge 1 corresponding to a condition of opening of the door 4 with an angle of approximately 160°, the first and second cylindrical cams 12a, 13a, 12b, 13b of the first and second operating units 12, 13 are fully spaced apart, being in contact in the respective flat portions of the respective profiles.

This circumstance determines a condition of maximum compression, that is, of maximum loading, of the helical spring 11 but also a condition wherein, as the curved portions of the profiles of the cams 12a, 12b, 13a, 13b are not operational, the spring 11 is not able to apply any closing force on the movable arm 3, thus defining a sort of stable position of equilibrium for the door 4.

In this configuration, definable conventionally also as the fully open configuration, the two first and second cylindrical cams 19a, 19b of the third operating unit 19 are, on the other hand, in a condition of maximum closeness, with the shock absorbing cylinder 21 substantially unloaded, that is, not operational.

Reference has been made to maximum opening since, as shown in FIG. 2a, the pin 7 comes into abutment against the end edge of the slot A of the movable arm 3.

Starting from that fully open configuration of the door 4, FIG. 3 shows the hinge 1 at an intermediate open configuration of the door 4, approximately corresponding to an angle of 90°.

In this configuration the first and second cylindrical cams 12a, 12b, 13a, 13b of the first and second operating units 12, 13 are still fully spaced apart, being in contact in the respective flat portions of the respective profiles.

Similarly, the two first and second cylindrical cams 19a, 19b of the third operating unit 19, although varying their reciprocal angular position, stay in their above-mentioned condition of maximum closeness, with the shock absorbing cylinder 21 not operational.

FIG. 3a shows the intermediate position of the pin 7 along the slot A of the movable arm 3.

Considering the configuration of the hinge 1 illustrated in FIG. 4, it corresponds to a condition of partial closing of the door 4, with an angle of approximately 30° relative to the complete closing.

In this configuration, the first and second cylindrical cams 12a, 12b, 13a, 13b of the first and second operating units 12, 13 enter into contact with the respective inclined portions of the respective profiles.

This condition of contact between the inclined profiles of the first and second cylindrical cams 12a, 12b, 13a, 13b of the first and second operating units 12, 13 allows the transmission of a twisting movement (deriving from the elastic force of releasing the helical spring 11) to the second cylindrical cams 12b, 13b and to the sleeve 9, thereby determining a closing action of the door 4 of the electrical household appliance.

As clearly illustrated in FIG. 4, the first and second cams 19a, 19b of the third operating unit 19 are also in contact with the respective inclined portions of its profiles, in a condition of moving away from one another.

Already starting from the configuration illustrated in FIG. 4, the third operating unit 19 operatively engages the shock absorbing cylinder 21 which therefore applies its shock absorbing action with respect to the closing of the door 4.

More in detail, the shock absorbing action of the shock absorbing cylinder 21 is exerted in the form of a twisting movement for the closing which through the second cylindrical cam 19b of the third operating unit 19 is transmitted to the sleeve 9 and, therefore, to the movable arm 3 integral with it,

In practice, the movable part 21b of the shock absorbing cylinder 21 is pushed towards the fixed part 21a as well as away from the two cylindrical cams 19a, 19b of the third operating unit 19, also by the movement of the second cam 13b of the second operating unit 13, using the appendages 20 of the second cam 19b of the third operating unit 19.

In effect, the appendages 20 allow a useful movement of the second cam 13b of the second operating unit 13 to be transmitted to the shock absorbing cylinder 21, without the affect of the opposing movement of the first cam 13a of the second operating unit 13.

As illustrated in FIG. 5 which shows a configuration of the hinge 1 corresponding to a closed condition of the door 4, the first and second cylindrical cams 12a, 12b, 13a, 13b of the first and second operating units 12, 13 are close together, determining a condition of maximum extension, that is, of minimum loading, of the helical spring 11.

In this configuration, definable conventionally also as the 0° angle configuration, the two first and second cylindrical cams 19a, 19b of the third operating unit 19 are, on the other hand, in a condition of maximum spacing, with the shock absorbing cylinder 21 substantially at the maximum of its deformation, that is, of its shock absorbing action.

In effect, in this configuration the component of movement of the movable part 21b of the shock absorbing cylinder 21 is also maximum due to the second cylindrical cam 13b of the second unit and transmitted to the third unit 19 through the appendages 20.

In short, as also already mentioned above, the above-mentioned appendages 20 entering into contact with the second cylindrical cam 13b of the second operating unit 13 increase the movement already set to the movable part 21b of the shock absorbing cylinder 21 by the relative movement between the cylindrical cams 19a, 19b of the third unit 19.

Advantageously, the use of two operating units, that is, the first 12 and the second 13, positioned to both sides of the helical spring 11, allows better use of the spring 11. With two separate operating units it is in effect possible to double the working stroke of the spring 11, also using thinner, and less expensive, springs.

The same elastic force can in effect be obtained with longer strokes with springs having a lower elastic constant, that is, with a thinner cross section.

Advantageously, the fact of having the spring unloaded with the door closed, which is the condition in which the system remains for the longest time, guarantees a longer life of the hinge since the spring is not stressed for most of the time and it therefore has a longer life.

Advantageously, the element 22 for adjusting the preloading allows the shock absorbing cylinder 21 to be adjusted to adapt the operation to different doors 4 and/or to different springs 11.

What is claimed:

1. A hinge for doors of electrical household appliances, comprising
a fixed body, connectable as one with a frame of the electrical household appliance,
a movable arm, connectable as one with a door of the electrical household appliance, pivoted on the fixed body to rotate about a respective axis of rotation (R), and designed to make the door movable relative to the frame between a closed position and an open position,
a control shaft, extending longitudinally parallel to the axis (R) and stably connected to the fixed body,
a sleeve integral with the movable arm, extending longitudinally parallel to the axis of rotation (R);
an elastic element, contained inside the sleeve and designed to generate an elastic force for closing the door,
means of actuating the elastic element to determine its deformation and transmit to the movable arm the closing force, the actuator means comprising at least one cylindrical cam operating unit housed inside the sleeve, the operating unit having a first and a second cylindrical cam operatively facing one another in such a way that the rotation of one about the axis (R) determines the translation of the other along the same axis (R) and vice versa, comprising shock absorbing means contained in the sleeve to impart on the movable arm, using the actuator means, a shock absorbing action in its movement relative to the fixed body, when the closing position of the door has nearly been reached.

2. The hinge according to claim 1 wherein one of the first and second cylindrical cams rotates as one with the shaft and the other of the first and second cams is slidably engaged with the sleeve, the actuator means comprising two cylindrical cam operating units, located on both sides of the elastic elements.

3. The hinge according to claim 2, wherein the cylindrical cam slidably engaged with the sleeve has a plurality of lateral appendages extending parallel to the axis of rotation (R), and in that the sleeve has a plurality of corresponding longitudinal sockets extending parallel to the axis (R), the sockets being designed to house the appendages and defining for them respective longitudinal guides of the translation of the cam.

4. The hinge according to claim 1, wherein the shock absorbing means comprise a fluid or gas cylinder mounted at least partly inside the sleeve.

5. The hinge according to claim 4, wherein the fluid or gas cylinder comprises a fixed part and a movable part relative to the sleeve, the shock absorbing action occurring following a relative movement of the fixed and movable parts, the actuator means comprising a third cylindrical cam operating unit, the third unit operating on the cylinder to impart a movement of the movable part.

6. The hinge according to claim 5, wherein a cylindrical cam of the third cylindrical cam operating unit comprises respective prolonged lateral appendages which project longitudinally beyond the overall dimensions of the cam until reaching an adjacent operating unit inside the sleeve.

7. The hinge according to claim 6, wherein the prolonged lateral appendages are designed to enter into contact with the longitudinally moveable cylindrical cam of the adjacent operating unit to increase the movement imparted on the movable part of the cylinder when the closing position of the door has nearly been reached.

8. The hinge according to claim 1, wherein the movable arm has a slot (A) with a circular extension concentric with the axis (R) and in that the fixed body supports a pin slidably engaged in the slot (A), the pin and the slot (A) defining an end stroke for the opening of the door relative to the frame.
